(19) United States
(12) Patent Application Publication
(10) Pub. No.: US 2010/0283788 A1
(43) Pub. Date: Nov. 11, 2010

(54) VISUALIZATION SYSTEM FOR A DOWNHOLE TOOL

(76) Inventors: Pascal Rothnemer, Paris (FR); Vincent Baur, Meudon (FR)

Correspondence Address: SCHLUMBERGER OILFIELD SERVICES, 200 GILLINGHAM LANE, MD 200-9, SUGAR LAND, TX, 77478, US

(21) Appl. No.: 12/744,362

(22) PCT Filed: Nov. 21, 2008
(86) PCT No.: PCT/EP08/09975

§ 371 Date: Jul. 19, 2010

(30) Foreign Application Priority Data
Nov. 29, 2007 (EP) 07121940.6

(51) Int. Cl. G06T 15/70

(52) U.S. Cl. 345/473

(57) ABSTRACT

Apparatus for visualizing a downhole tool in a subsurface environment. The apparatus comprising: an input for receiving data on at least one of the downhole tool and the subsurface environment, a physical model processing said input for generating a representation of the downhole tool moving through said subsurface environment and an output for displaying said downhole tool movement in real-time.

### FIELD

The invention relates to an apparatus and method for visualizing a downhole tool in a subsurface environment, and in particular but not exclusively in a subsurface environment where hydrocarbons are being explored.

### BACKGROUND

Hydrocarbon energy prospecting methods are continually being refined. Such hydrocarbon operations involve not only prospecting, but drilling and often logging operations. Indeed such logging operations might involve measurement before, during or after drilling.

There are many different downhole tools and operations that can be performed. Often a user such as a tool controller or reservoir engineer on the surface would like to have an indication of the situation downhole. For example, the user might want to lower the tool to a certain depth to make a particular reading of the surrounding formation or the tool might need to be positioned in a particular orientation in the borehole to perform a particular type of measurement. In order to locate the tool, the user needs to reconstruct in his mind what the downhole environment might be like by taking into account the range of different sensor readings that are feedback to him on the surface.

Often these sensor reading are numerical and/or there are so many of them that it becomes difficult for the user to collate all the information to build up a picture of how the tool might be interacting with the environment. Moreover, it takes time to process the information and often requires a skillful and experienced user to make sense of all the information received.

Other techniques are known for providing a visualization of a well trajectory, i.e. tools which allow a user to obtain a visual plot of the trajectory of a borehole's direction drilled into a subsurface formation. Such techniques are described for example in granted patents U.S. Pat. No. 6,885,942 and U.S. Pat. No. 6,917,360 as well as published patent applications US2003/0043170A1, US2004/0204855A1 and US 2005/0216197. The granted patent U.S. Pat. No. 7,027,925 goes further in providing a system for the visualization of a BHA (bottomhole assembly) within a borehole trajectory. However, these techniques are all limited in that they are not capable of capturing dynamically changing tool behavior.

Thus, it is desirable to provide a visualization system that is able to overcome these disadvantages and provide a more accurate representation to a user.

### SUMMARY

According to one aspect of the present invention there is provided an apparatus for visualizing a downhole tool in a subsurface environment, the apparatus comprising: an input for receiving data concerning at least one of the downhole tool and the subsurface environment; a physical model processing, said input for generating a representation of the downhole tool moving through said subsurface environment; and an output for displaying said downhole tool movement in real-time.

Thus, the physical model advantageously enables the processing of a complex input to be displayed in visually animated form to a user in real-time. This enables better and quicker control and/or positioning of the downhole tool and improves in reducing the costs both in terms of resources and time in operation of the downhole tool.

Preferably, the physical model comprises: a tool model for representing a plurality of geometrical components that constitute the downhole tool; and a subsurface model for representing a plurality of parameters that constitute the subsurface environment.

Preferably, wherein the input comprises: a first input having data concerning at least one of the components of the downhole tool; a second input having data concerning at least one of the parameters of the subsurface environment; and a third input having a-priori data concerning at least one of the downhole tool, the subsurface environment and a relationship between the downhole tool and the subsurface environment.

The advantage of this is that the input can be a complex input which is able to combine a plurality of inputs simultaneously and hence arrived at an updated model which is updated in real-time and more accurate.

Preferably, the physical model further comprising a behavioral model representing a dynamic behavior of at least one of the components of the tool based on at least one of the subsurface parameters.

This is advantageous in that it enables the physical model of the tool to be enriched with the interactive relationship between the environment and the tool and their effects on one another, making the representation even more accurate.

Preferably, wherein the apparatus is used in a logging tool during which a plurality of measurements of a formation in the subsurface environment are performed.

Preferably, wherein the logging tool measurement is performed either during or after drilling and/or is able to be lowered into a borehole in a wireline operation.

According to another aspect of the present invention there is provided a method for visualizing a downhole tool in a subsurface environment, the apparatus comprising: receiving data on at least one of the downhole tool and the subsurface environment; processing said input for generating a representation of the downhole tool moving through said subsurface environment; and displaying said downhole tool movement in real-time.

### LIST OF DRAWINGS

Embodiments of the present invention will now be described by way of an example with reference to the accompanying drawings, in which:

FIG. 1 shows an example of a basic wireline application;

FIG. 2 shows a block diagram of the physical model according to an embodiment

FIG. 3 shows a representation of the downhole tool as produced by the tool model according to an embodiment;

FIG. 4 shows an example of the animated display of the tool as it moves through the subsurface environment; and

FIG. 5 shows an example of further scenes in a screenshot display.

### DESCRIPTION

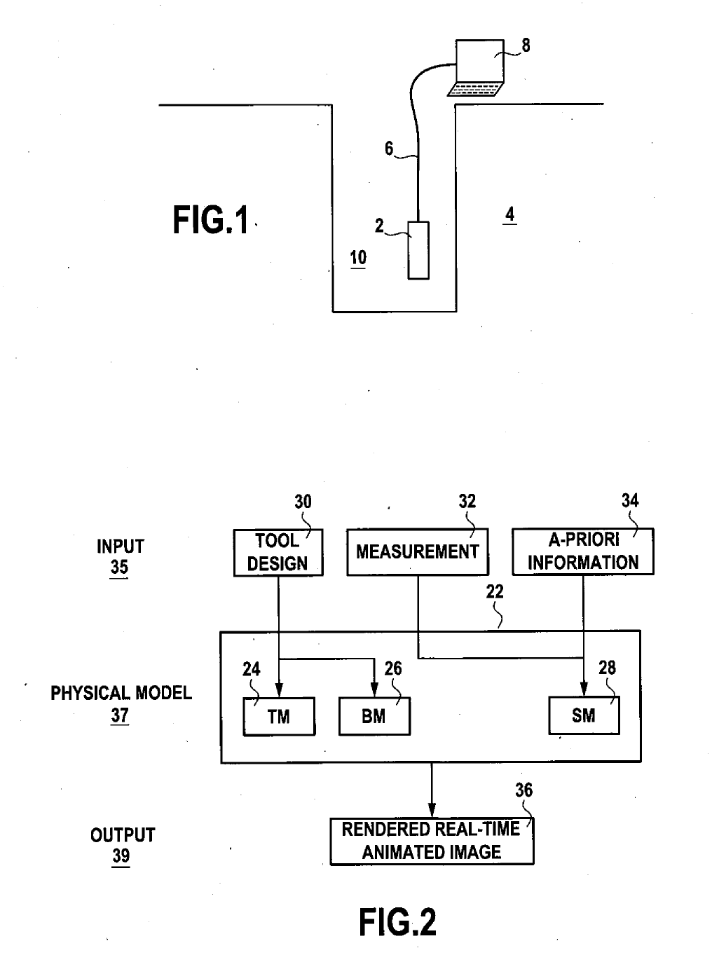

FIG. 1 shows a basic view according to a wireline embodiment, in which a borehole 10 has already been drilled down into the earth's surface and a downhole tool 2, in this example a logging tool, is suspended from a wire or cable 6 and controlled by a user on the surface.

Specifically, the user is able to visualize and/or control the downhole tool 2 by way of a user equipment 8 that might for example comprise typical components of a PC including an I/O (input/output unit) and a processing unit (not shown). The I/O unit comprises for example a monitor device for displaying the downhole tool 2. The processing unit being programmed with a physical model which acts on received inputs to render an image of the downhole tool 2 in its subsurface environment.

At least some of the inputs might be located downhole on the downhole tool, which can communicate with the user equipment on the surface by known data communication means, i.e. either by wired communication link or by a wireless telemetry method.

The I/O unit (not shown) in one embodiment comprises user input means like a mouse, touch screen or keyboard (not shown) for allowing a user to select different scenes or angles from which to view the rendered geometrical image of the downhole tool to be displayed on the output device (monitor). The user is thus able to visualize the location and/or orientation of downhole the tool, or the various components that constitute the tool, in a real-time manner for controlling the tool, or its constituent components, accordingly.

It should be appreciated that this is only one application of the visualization system of the present application, but there are other important applications that also exists while drilling the borehole itself and/or avoiding obstacles that might be detected. Specifically, the real-time nature of the tool allows a change of direction to be made rapidly and moreover, the more accurate detail of the orientation of the tool, would allow a user on the surface to make the necessary control signals for drilling in a different direction a lot easier.

FIG. 2 shows a block diagram of the functionality according to an embodiment of the invention as having an input section 35 to a physical model section 37 which produces an output section 39.

The input section 35 comprises at least one of a tool design input 30, a measurement input 32 and an a-priori information input 34. The tool design input comprises for the actual mechanical parameters of the tool and/or its constituent components, for example the minimum and maximum extensive of the caliper components of the tool. The measurement input comprises measurements taken from sensors for example the lithology of the formation 4 and/or dips, and also the borehole dimensions around the tool (i.e. diameter). It might also comprise sensor measurements giving the actual extension of the calipers as the tool 2 moves through the subsurface environment. The a-priori information is information that is known beforehand, which might be stored in a database. Examples of such a-priori information include the tubing entry depth, casing shoe, secondary borehole position, etc.

The physical model section 37 is represented by the physical model 22, which comprises a tool model 24, a behavioral model 26 and a subsurface model 28.

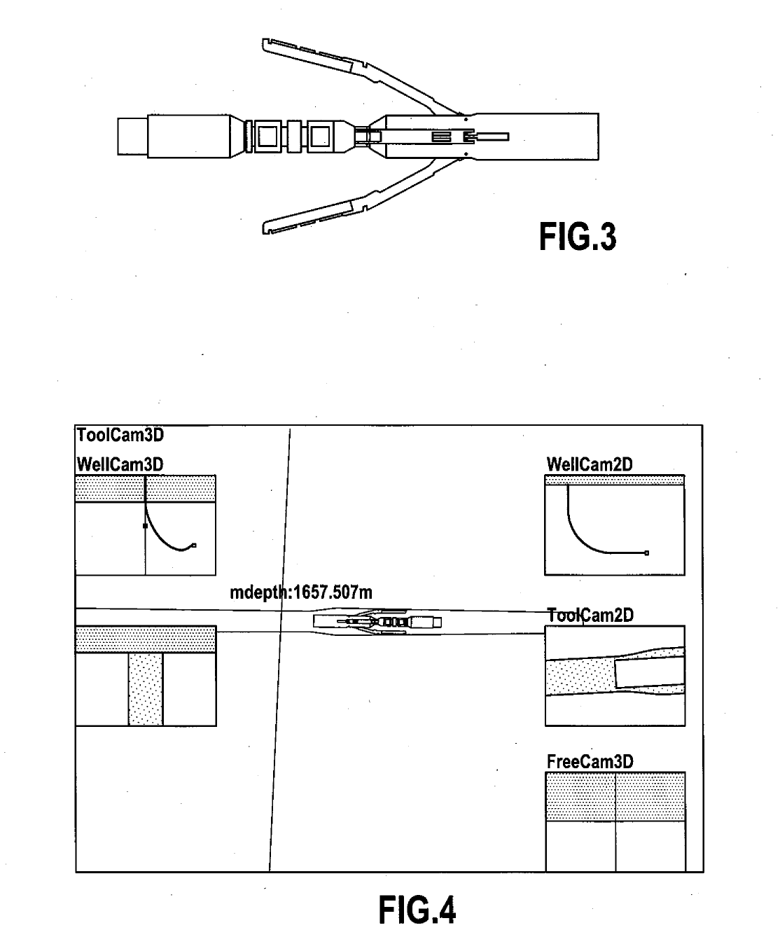

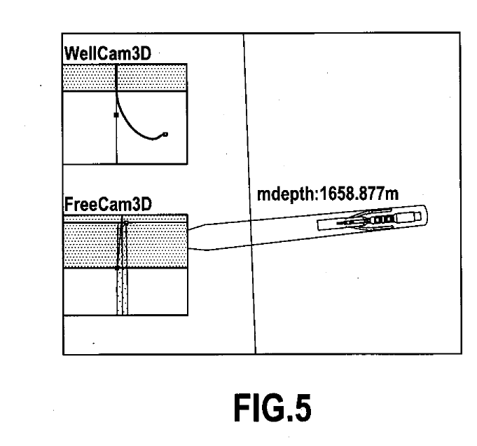

The tool model 24 provides an accurate geometrical model of the downhole tool itself and/or its constituent components. It is implemented by adapting computer assisted design (CAD) techniques, which decomposes the downhole tool 2 into as many mobile components that exist on the tool. FIG. 3 shows a representation of the downhole tool in 3D using a PRO Engineer CAD model. This model is created for mechanical simulation and has the dimensions of the actual downhole tool's components. For example, one part of the tool 2 is the mandrel (or body of the tool), while the outer is the calipers that move independently from the mandrel (as will be described in the FIG. 4 example). The tool model 24 is then able to recreate a virtual image of the actual tool by geometrically modeling the independently moving parts of the tool and uses the tool design input 30 to accurately represent each of these components of the tool such that the final rendered image that is output is accurate and the various elements are too the right scale.

The subsurface model 28 provides an accurate model of the subsurface environment surrounding the tool. Specifically, the subsurface tool is able to receive the measurement input 32 and/or a-priori input 34 and to generate a model representing various qualities of the environment. For example, the subsurface model is able to render a trajectory of the borehole and/or the dimensions of the borehole (such as its varying diameter of the borehole, dips in the formation, etc).

The behavioral model 26 represents the functionality which is able to combine the relationship between the tool model 24 and the subsurface model 28 and their effects on one another. Simply put, the model represents a description of the how the tool reacts to different environmental subsurface events. For example, it models the behavior of how the caliper extends when the borehole diameter enlarges or conversely, retracts when the borehole diameter decreases. The behavioral model 26 is also able to draw on the tool design input 30 so that for example it is known the caliper will natural extend to a certain position as a result of a coil controlling the calipers movement downhole and whose properties are known.

FIG. 4 shows an output of an actual downhole example in which the diameter of the borehole varies. Specifically, FIG. 4 shows a plurality of different scenes, but it can be seen that the downhole tool 2 enters at some point into a borehole having a larger diameter wherein the calipers extend themselves, in a movement defined and modeled by the coil, such that calipers are controllably maintained against the borehole wall. For example, the calipers might contain electrode pads for performing measurements of the formation, it being desirable to keep these flush with the borehole wall as the downhole tool 2 moves through the borehole. Similarly, if the tool moves into a reduced borehole diameter the caliper retracts itself as the coil is compressed by the pressure exerted on it by the receding borehole face.

Thus, in this manner a user on the surface is not only able to be provided with views showing the trajectory of the downhole tool in a real-time manner, but also is able to monitor the orientation and movement of independent components of the tool as they are updated in real-time. Finally, the output is also able to take into account the changing geometry of the borehole and model the effect of this on the behavior of the tool.

Thus, returning to FIG. 2, the output section 39 is represented by the output block 36 which is the rendered real-time image. A further advantage of the tool is that it allows the image to be rendered as if viewed from different camera angles. The system allows both 2D (two-dimensional) and 3D (three-dimensional) images to be rendered. As can be seen in the example screenshot of FIG. 4 there are a plurality of different views. More specifically, it is the dynamic nature of the physical model of the tool, which allows information from a combination of different inputs to be collated into an animated accurate model which is updated in a substantially real-time fashion as the tool moves through the borehole.

The user equipment 8 shown in FIG. 1 might also comprise video storage and playback functionality for recording the animated movements of the tool. In this way, a user can go back and scrutinize a particular operation by playing it back or stopping the frame at a particular point in time and requesting a different view or scene at that point in time to be rendered.

Thus, the system allows reliable monitoring in real-time or replay mode of a downhole logging tool having mobile parts moving dynamically and independently through a well. In a preferred embodiment, CAD programs are adapted to generate realistic animated 3D views of the mobile parts in action enabling better, safer and faster operation control. Specifically, it is now possible to monitor the behavior of a mechanical device in action and/or in motion within a well to better control its operation. Downhole devices such as logging tools, so-called Wireline or D&M (Drilling and Measurement) tools, can be viewed in action as if they were filmed by one or more cameras. The scenes encompass at large scale the well trajectory and the surrounding formation, and at reduced scale the tool itself with its mobile devices in action: calipers, anchors, pistons, pads, or any mobile mechanical device. The realism of the animation is granted by the use of actual measurements relative to the well and the formation, and of the CAD tool model to represent it, providing the exact dimension, proportion, aspect and texture. The tool motion itself is modeled based on the physical model.

This physical model is therefore able to render a real-time animated 3D view which helps in better and faster understanding where the downhole device is, what it is doing and in which state it is. Specifically, the physical model is able to infer from measurements a more accurate representation of the downhole tool's behavior. Instead of relying on numerical values, the operator of such activity may realize at a glance the actual downhole situation, which can lead to a significant advantage during critical phases of the operation.

In a well logging operation, whether performed via D&M or Wireline, the logging tool is placed into a well and performs one or several up and down passes during which measurements are recorded from its sensors. Depending on the nature of the tool, mobile mechanical devices are involved, such as calipers, anchors, pistons, pads, etc. Such an operation is traditionally largely conducted in a blind-fold manner. That is, the user/operator traditionally relies on numbers and log curves provided by the acquisition system to build his/her view of what is happening downhole. The tool position within the well trajectory, its position with respect to the borehole, casing shoe, tubing entry, cannot be perceived immediately but must be inferred in the operator's mind based on numbers and measurement curves. This can lead in some cases to a delay and/or to a possible wrong appreciation of what is actually happening. This may negatively impact the logging operation, both in terms of quality and safety.

Instead embodiments of the present invention enable the generation of realistic animated 2D and 3D views related to large and small scale downhole events of interest to better understand the operation and assess its quality.

An embodiment for implementing the invention relies on a software application of the acquisition system and models for generating the animated scenes. An easy navigation through the 3D or 2D space also allows the user to focus on the tool itself or to enlarge the view to encompass the whole well trajectory and formation.

A further embodiment comprises a package comprising a stored video clip of a recorded animation with the software (computer program) to play it, which can be sold as a separate kit to a client. The client may have additional tools to assess and interpret the recorded data in an even better way.

It should be appreciated that while the physical model in FIG. 2 is shown to comprise separate models this is for illustrative purposes only and this functionality might be contained in a single processing unit or may be contained in separate units.

It should also be appreciated that CAD PRO Engineer program is only one way of creating the geometric model for representing the tool and others programs are also possible that are able to represent the downhole tools with varying degrees of complexity. For example, the downhole tool can generally be rendered as a succession of cylinders or with more complicated simple or fixed devices such as stabilizers, etc.

1. Apparatus for visualizing a downhole tool in a subsurface environment, the apparatus comprising:
an input for receiving data concerning at least one of the downhole tool and the subsurface environment;
a physical model processing said input for generating a representation of the downhole tool moving through said subsurface environment; and
an output for displaying said downhole tool movement in real-time.

2. The apparatus of claim 1, wherein the physical model comprises:
a tool model for representing a plurality of geometrical components that constitute the downhole tool; and
a subsurface model for representing a plurality of parameters that constitute the subsurface environment.

3. The apparatus of claim 2, wherein the input comprises:
a first input having data concerning at least one of the components of the downhole tool;
a second input having data concerning at least one of the parameters of the subsurface environment; and
a third input having a-priori data concerning at least one of the downhole tool, the subsurface environment and a relationship between the downhole tool and the subsurface environment.

4. The apparatus of claim 2, wherein the physical model further comprising a behavioral model representing a dynamic behavior of at least one of the components of the tool based on at least one of the subsurface parameters.

5. The apparatus of claim 4, wherein the first input is received by at least one of the tool and behavioral models, and wherein at least one of the second and third inputs are received by the subsurface model.

6. The apparatus of claim 1, wherein the physical model is dynamically updated depending on the input such that the output is displayed to a user in an animated real-time manner representing a dynamic behavior of the downhole tool progressing through the subsurface environment.

7. The apparatus of claim 1, wherein the output is capable of being displayed to a user in a plurality of different forms.

8. The apparatus of claim 7, wherein the plurality of different forms include at least one of a two-dimension profile view, a three-dimension profile view and other non-profile views of a changeable angle.

9. The apparatus of claim 1, wherein the apparatus is used in a logging tool during which a plurality of measurements of a formation in the subsurface environment are performed.

10. The apparatus of claim 9, wherein a user is arranged to perform said measurements by controlling the logging tool based on the real-time visual display provided by the output of the visualization apparatus.

11. The apparatus of claims 9, wherein the logging tool measurement is performed during drilling of a borehole in the subsurface environment.

12. The apparatus of claims 9, wherein the logging tool measurement is performed after drilling and lowered into a borehole in a wireline operation.

13. The apparatus of claim 2, wherein the tool model is generated based on computer-aided design (CAD) programming that provides a geometrical representation of the downhole tool.

14. The apparatus of claim 13, in which the downhole tool is broken down into modular component parts.

15. The apparatus of claims 13, in which the CAD programming is able to provide downhole tool providing at least one of the exact dimension, proportion and texture of the downhole tool.

16. The apparatus of claim 1, wherein the apparatus further comprising:
storage means for recording real-time scenes of a downhole tool moving through the subsurface environment, and
video control means for being able to play back the recording at a later time by a user.

17. The apparatus of claim 1, wherein the input is located downhole at a location remote from the physical model at a located on the surface.

18. A method for visualizing a downhole tool in a subsurface environment, the apparatus comprising:
receiving data concerning at least one of the downhole tool and the subsurface environment;
processing said input for generating a representation of the downhole tool moving through said subsurface environment; and
displaying said downhole tool movement in real-time.
